(19) United States
(12) Patent Application Publication
(10) Pub. No.: US 2009/0131079 A1
(43) Pub. Date: May 21, 2009

(54) METHODS AND SYSTEMS FOR DELIVERING INFORMATION TO MOBILE DEVICES

(75) Inventor: Ramesh SEKHAR, San Jose, CA (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 11/941,278

(22) Filed: Nov. 16, 2007

(51) Int. Cl. H04Q 7/20

(52) U.S. Cl. 455/456.3; 455/41.2; 455/456.1

(57) ABSTRACT

A system for delivering information to a mobile device includes a server; and a beacon coupled to and receiving information from the server. The beacon is configured to provide a message based on the information to the mobile device when the mobile device is within a transmitting range.

### TECHNICAL FIELD

The present invention relates to methods and systems for delivering information to mobile devices. More particularly, the present invention relates to methods and systems for delivering information to mobile devices with beacons.

### BACKGROUND

Recent years have seen a great increase in subscribers to mobile telephone networks. Through advances in technology and additional functionalities, cellular telephones and other wireless communication devices have become personal, trusted devices. As a result, a mobile information society is developing, with personalized and localized services becoming increasingly important.

The availability of various types of wireless communication devices produces a need to have these devices interact with each other in a manner that is cost efficient and easily implemented. Such communication can occur in GSM systems using SMS for communicating short messages directly between two or more terminal devices, such as mobile stations, e.g. telephones, PDAs, etc. Devices can also communicate with each other using infrared signals or radio frequency (RF) signals. “Bluetooth” technology allows devices that are located within an operable range of the RF system to communicate with each other.

Accordingly, even with advances in wireless technology, there is a continuing need to deliver useful information to users at a particular location. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a block diagram of a system for delivering information to a mobile device in accordance with an exemplary embodiment;

FIG. 2 is a block diagram of a beacon utilized in the system of FIG. 1; and

FIG. 3 is a block diagram of a mobile device utilized in the system of FIG. 1.

### DETAILED DESCRIPTION

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission and data formatting protocols and that the system described herein is merely one example embodiment of the invention.

For the sake of brevity, conventional techniques related to signal processing, data transmission, signaling, network control, the 802.11 family of specifications, wireless networks, RFID systems and specifications, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example,” rather than “model.” Although the figures may depict example arrangements of elements, additional intervening elements, devices, features, or components may be present in an embodiment of the invention.

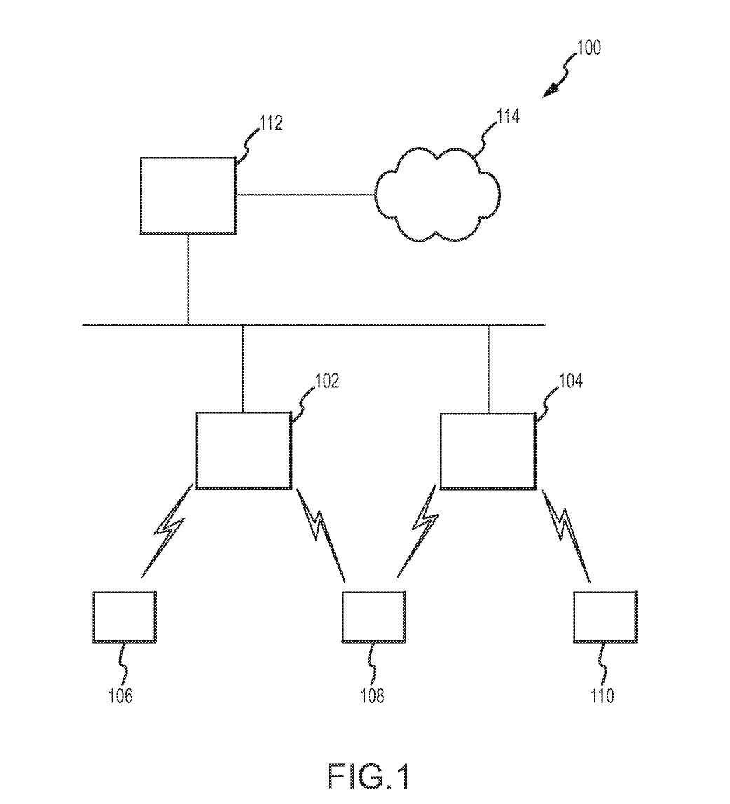

FIG. 1 schematically shows a system 100 comprising a plurality of beacons 102, 104 distributed over a series of locales. The term “beacon” refers to a wireless store/forward transceiver relay device, as explained more fully below, for storing short messages and transmitting the stored messages. Each of the beacons 102, 104 broadcasts in a wireless fashion one or more short range signals, using a short range wireless communication protocol. The wireless broadcasts can be compatible with Bluetooth or IEEE 802.11 or 802.11b Wireless LAN technologies. In one embodiment, the beacons 102, 104 are radio-type beacons that regularly broadcast messages in accordance with an 802.11 protocol, for example, every 100 ms.

The beacons 102, 104 are enabled to communicate with one or more mobile devices 106, 108, 110. The mobile devices 106, 108, 110, which in one embodiment are mobile phones, have the capability to receive the short range wireless communication from the beacons 102, 104. In the depicted embodiment, mobile devices 106 and 108 are within the broadcast range of beacon 102, and mobile devices 108 and 110 are within the broadcast range of beacon 104. The mobile devices 106, 108 receive respective broadcast signals and process them, for example, to display a message on a display screen.

The beacons 102, 104 exchange data with a server 112. The server 112 can, for example, be connected to a network 114, such as the Internet, a phone network or a cable network. In an exemplary system 100, the server 112 can be a switching device (alternatively referred to as an “RF switch,” “WS,” or simply “switch”). In one embodiment, the server 112 can determine the destination of packets it receives over network 112 and route those packets to the appropriate beacon 102, 104. Suitable technologies for the wireless transmissions are for example the General Packet Radio Service (GPRS) or the Universal Mobile Telecommunications System (UMTS).

The system 100 provides an implementation of an infrastructure for use in points of interest such as, for example, department stores, shopping malls, automotive dealerships, theme parks, airports, stadiums, etc. The system 100 may be used to provide location-specific information such as local maps, information on nearby services and products and so on, with the beacon 102, 104 downloading information to the mobile devices 106, 108, 110, preferably in the form of messages. The beacons 102, 104 can provide information and services to anyone within its range. Since the range is limited, depending on the technology used, it is possible to offer localized information and services.

The beacon 102, 104 will generally cyclically broadcast a number of messages, each typically relating to a different service. The messages provided by the beacons 102, 104 to the mobile devices 106, 108, 110 will be discussed in further detail below after a more detailed description of the beacons 102, 104 and mobile devices 106, 108, 110.

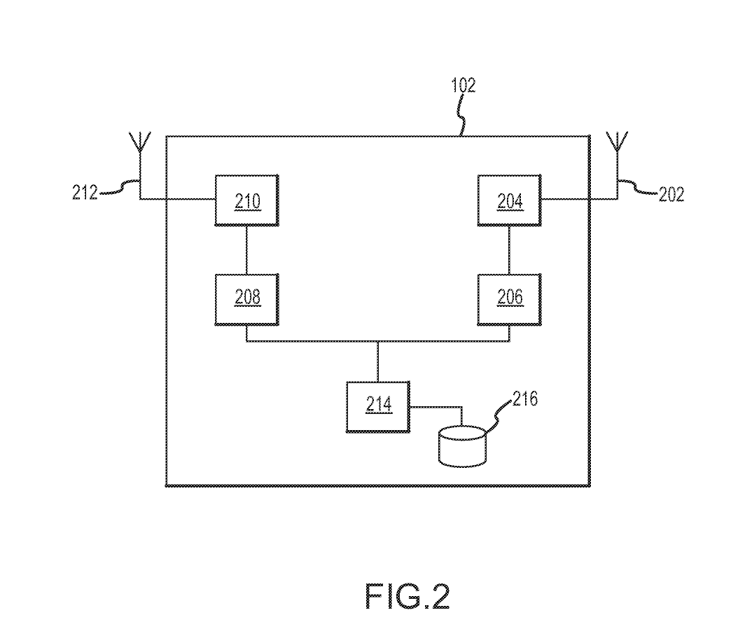

FIG. 2 is a block diagram of the beacon 102, although it could also represent beacon 104. The beacon 102 includes an antenna 202 coupled to a short range transceiver 204 for the transmission and reception of data. A short range communication module 206 broadcasts information and communicates with devices in the vicinity via the short range transceiver 204 and the antenna 202 using a short range wireless communication technology such as Bluetooth, IEEE 802.11 or 802.11b Wireless LAN. A wireless transmission module 208 is coupled to a cellular transceiver 210 and antenna 212 for communicating with the server 112 using technology such as GPRS or UMTS. In an alternate embodiment, the transceivers 204, 210 and the transmission modules 206, 208 can be combined into one or more components.

The beacon 102 is further equipped with a local processor 214 and local storage 216 such as a hard disk or solid state memory. Using the local processor 214 and the local storage 216, the beacon 102 can interact autonomously with any device that can pick up the broadcasted transmission to provide an information service. The local storage 216 in the beacon 102 is preferably loaded by a transmission from the server 112 to the beacon 120.

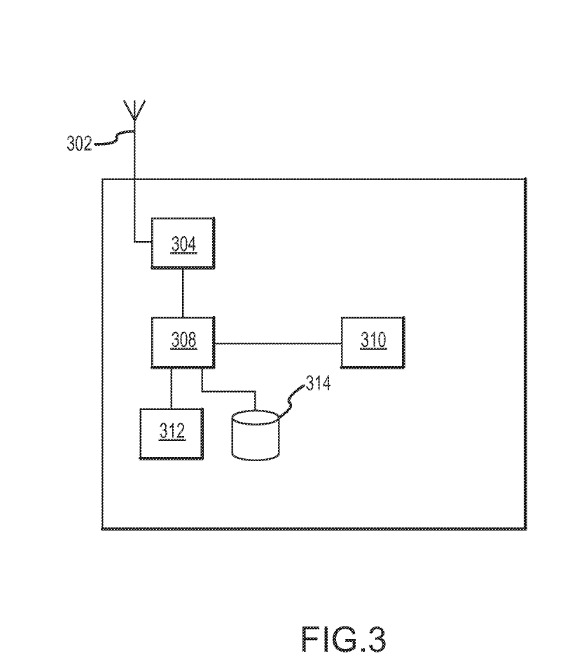

FIG. 3 schematically shows the mobile device 106 in more detail, although it could additionally refer to mobile devices 108 or 110 (FIG. 1). The mobile device 106 includes an antenna 302 coupled with a transceiver 304 for the reception and transmission of messages. The transceiver 304 is coupled to a processor 308, which in turn is coupled to local storage 314, a user input mechanism 314, and a display 310.

Outgoing messages can result from user input via the input mechanism 314. These inputs are converted into a message data format and converted to a transmission format by the processor 308 before being supplied to the transceiver 304.

Messages received via the antenna 302 and transceiver 304 are passed to the processor 308 for decoding and filtering. If the data carried by the message is for presentation on a display screen 310 of the mobile device 106, the data is suitably formatted by the processor 308.

In one embodiment, the processor 308 includes a web browser. The messages from the beacons 102, 104 can include URLs, such that the web browser can enable the display screen 310 to display the website associated with the URL.

Referring again to FIG. 1, the beacon 102, 104 can be is installed in a retail location to entice passers-by to enter and shop. The beacon 102, 104 is loaded with the logo of the retail location, photographs of the interior, types of goods sold at the retail location, hours of operation, and items for sale. Accordingly, the beacon 102, 104 is able to autonomously interaction with people that pass the retail location.

The mobile devices 106, 108, 110 within the range of the respective beacon 102, 104 pick up the broadcasted transmission and present the information provided in the message. This information may be provided in stages, with an initial information broadcast. Then, if the user is interested and wants further information, the message can include a URL to access the internet via the user's mobile device 106, 108, 110 or a telephone number for calling via the user's mobile device 106, 108, 110. In another embodiment, all necessary information can be included in the initial message.

In one embodiment, the mobile device 106, 108, 110 has the ability to filter the messages received according to pre-stored user preferences, and the user is only alerted if comparison of stored preference data and subject matter indicators in the message indicate that an item of data of particular interest has been received.

The user of the mobile device 106, 108, 110 can browse through the received messages, and make a selection. This selection or indication is then transmitted back to the beacon 102, 104, which may, in response, transmit more detailed messages regarding the selection or indication. By way of example, shops might choose to provide details of special offers into passing mobile devices 106, 108, 110 in the knowledge that users who have interest and have therefore set their filters accordingly will be alerted by their mobile devices 106, 108, 110.

Communication between the mobile devices 106, 108, 110 and the beacons 102, 104 can take two forms: “push” and “pull”. In “push” mode, information is broadcast in various forms according to the application but will generally include a concise description of the information being sent and a pointer to fuller information, e.g. a URL identifying a service provider.

Sometimes the user will wish to obtain more information than is contained in the keys. Here, “pull” mode allows a user to set up a connection with the beacons 102, 104 and actively request information to pull down into the mobile devices 106, 108, 110. This mode is therefore typically interactive.

In one embodiment, the beacons 102, 104 autonomously perform interactive services with the mobile devices 106, 108, 110. In the illustrative embodiment, the respective beacon 102, 104 broadcasts a global overview of the information provided by the beacon 102. The user of the respective mobile device 106, 108, 110 can indicate his preference for the types of items in the overviews. The beacon 102, 104 receives this indication and passes it on to the local processor 214. The beacon 102, 104 then selects additional information matching the indicated preference, which overview is then transmitted to the mobile device 106, 108, 110.

While the beacons 102, 104 will typically be independent of one another (in a shopping mall set up, each shop provides and maintains its own beacon without reference to any beacons provided by neighboring shops), the beacons 102, 104 may be arranged to exchange information with each other. The beacons 102, 104 can be interconnected using the wireless link, so again no extra infrastructure is necessary.

The messages received by the mobile device 106, 108, 110 can be private messages or public messages. Private messages are transmitted from a subject beacon 102, 104 to an intended recipient when the intended recipient enters into the operating range of the beacon 102, 104 and the intended recipient device is detected. The receipt's mobile device 106, 108, 110 can be recognized by an infrared and/or Bluetooth function. Once the mobile device 106, 108, 110 is identified, the private message will be transmitted automatically from the subject beacons 102, 104 containing the private message. The message can be encrypted, and after receipt, the message can be decrypted such as by entering an encryption password.

Public messages may be used, for example, in advertising, to inform potential customers of sales promotions offered by an establishment proximate a specific beacon 102, 104. As users enter the operating area of the specific beacon 102, 104 the user may obtain access to a message describing the particular sales promotion. Public messages may also include for example general information related or tailored to a geographic location containing the beacon 102, 104, such as providing mass transit time tables for trains or buses departing from or arriving at the geographic location, as well as theater performance times for events at a theatre in the operating range of the subject beacon, and the like.

Messages may be stored in categories by subject matter. Access to messages can then be requested by a recipient when the recipient enters into the operating range of a specific beacon 102, 104. For example, a recipient can execute a command to receive a category list or menu of messages (e.g. clothing offers, food promotion, etc.) and then select the category of messages to be transmitted by the beacon 102, 104. Once the category is transmitted, the messages in the category can be viewed and a particular message can be selected for transmission by the beacon 102, 104 to the recipient device. Alternatively, public messages can be automatically transferred to a recipient device upon entry of the recipient into the operating area of the beacon 102, 104, i.e. without requiring the user to initiate a request.

Accordingly, exemplary methods and systems for delivering information to mobile devices with beacons have been provided. While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A system for delivering information to a mobile device, comprising:
a server; and
a beacon coupled to and receiving information from the server, the beacon configured to provide a message based on the information to the mobile device when the mobile device is within a transmitting range.

2. The system of claim 1, wherein the beacon comprises a transceiver for providing the message to the mobile device in accordance with IEEE 802.11 or Bluetooth technology.

3. The system of claim 1, wherein the beacon includes an 802.11 radio.

4. The system of claim 3, wherein the 802.11 radio transmits the message at regular intervals.

5. The system of claim 4, wherein the 802.11 radio transmits the message every 100 ms.

6. The system of claim 1, wherein the message includes an embedded URL for directing a user of the mobile device to a website.

7. The system of claim 1, wherein the beacon is configured to detect a mobile phone within the transmitting range.

8. A method of providing information, comprising:
positioning a beacon in a location; and
transmitting a message stored in the beacon to a mobile device within an operating region associated with the location.

9. The method of claim 8, wherein the transmitting step includes transmitting the message in accordance with IEEE 802.11 or Bluetooth technology.

10. The system of claim 8, wherein the transmitting step includes transmitting the message with an 802.11 radio.

11. The method of claim 10, wherein the transmitting step includes transmitting the message at regular intervals.

12. The method of claim 11, wherein the transmitting step includes transmitting the message every 100 ms.

13. The method of claim 8, wherein the message includes an embedded url for directing a user of the mobile device to a website.

14. The method of claim 8, further comprising detecting the mobile device within the operating range of the beacon.

15. An information system, comprising:
a server;
a beacon coupled to and receiving information from the server, the beacon configured to transmit a message within a transmitting range based on the information; and
a mobile device configured to receive and display the message from the beacon when the mobile device is within the transmitting range.

16. The system of claim 15, wherein the beacon comprises a transceiver for providing the message to the mobile device in accordance with IEEE 802.11 or Bluetooth technology.

17. The system of claim 15, wherein the beacon includes an 802.11 radio for transmitting the message at regular intervals.

18. The system of claim 15, wherein the message includes an embedded url, and the mobile device is configured to display a website based on the url.

19. The system of claim 15, wherein the beacon is configured to detect the mobile phone when the mobile phone is within the transmitting range.

20. The system of claim 15, wherein the mobile device includes a processor configured to filter through a plurality of the message such that only messages of interest to a user of the mobile device are displayed.
